(19) United States
(12) Patent Application Publication
(10) Pub. No.: US 2003/0077560 A1
(43) Pub. Date: Apr. 24, 2003

(54) Medical education system

(75) Inventor: Mark Allyn Colby, Tokyo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Integrated Medical Advancement, Ltd.

(21) Appl. No.: 10/272,529

(22) Filed: Oct. 15, 2002

(30) Foreign Application Priority Data
Oct. 12, 2001 (JP) 2001-314750

(51) Int. Cl. G09B 3/00; G09B 7/00

(52) U.S. Cl. 434/322

(57) ABSTRACT

Provided is a system capable of efficiently providing education to busy persons; for example, medical practitioners working at medical care facilities, without placing any burden space-wise or time-wise. A network system in which a terminal 20 comprising a communication unit and an education system server 10 are connected communicably via a network, wherein the terminal 20 has an education implementation unit having a function of displaying a question and processing an answer to this question, and a communication control unit for transmitting to the education system server the result of the processed answer to the question; and the education system server 10 has a test result storage unit for storing by participant the processed result of the answer received, and a test result editing unit for appropriately editing and outputting the test results in accordance with the request from the terminal.

### FIELD OF THE INVENTION

The present invention pertains to an education system utilizing a network, and particularly to a system for educating practitioners such as physicians and nurses working at medical care facilities.

### BACKGROUND OF THE INVENTION

Today, development in various technical fields, particularly medical technology, is showing constant advancement and, in accordance with such advancement, the necessity of educating the practitioners working at medical care facilities is increasing.

In the world of medical practice, pursuant to this kind of advancement in medical technology, international accreditation organizations such as CAP (College of American Pathologists, ISO (International Organization for Standardization) and so on set forth a fixed criterion and standard regarding medical technology including definite safety measures, and accredits and certifies whether the respective medical institutions and medical practitioners are satisfying such criterion and standard. As a result of receiving such accreditation or certification, the respective medical institutions may improve the quality of its facilities and medical practitioners, clarify the reliability to the society, and further provide high quality medical services to patients.

When the respective medical institutions are to provide education accompanying the advancement in medical technology; for example, upon providing education for receiving the accreditation or certification from the foregoing institutions, it is necessary to gather essential information from the accreditation organization, and, based on such information, the respective medical institutions must independently improve the medical facilities or educate the medical practitioners.

### SUMMARY OF THE INVENTION

When personnel are to be educated as described above, it is necessary for them to commute to a specific educational site to take courses. When adopting this kind of learning method, there is a possibility that this will be detrimental to the busy day-to-day medical services.

For instance, in order to receive the accreditation or certification in the foregoing medical fields, it is necessary to secure the place and time for conducting the specialized educational program, and there is a possibility that this will be detrimental to the day-today business of medical practitioners who are pressed by their work schedule. Moreover, these procedures must be implemented once again if the accreditation/certification standard is changed, and the burden on medical institutions and medical practitioners will increase as a result thereof.

In order to deal with the above, desired is an environment where busy persons can use their spare time to effectively learn new technology.

In consideration of the above, an object of the present invention is to provide a system capable of efficiently providing education to busy persons; for example, medical practitioners working at medical care facilities, without placing any burden space-wise or time-wise.

For example, the present invention provides, to medical institutions and medical practitioners aiming to acquire the accreditation or certification of CAP or the like, a medical education system for supporting the efficient acquirement of such accreditation or certification without placing any burden space-wise or time-wise.

The education system of the present invention is a network system wherein a terminal having a communication means and an education system server are connected communicably via a network.

Here, a terminal shall include portable computers; for instance, a personal computer, a portable telephone, a PDA (Personal Digital Assistant), and so on.

(Network System)

[1] The first aspect of the present invention is a network system in which a terminal comprising communication means and an education system server are connected communicably via a network, wherein the terminal comprises education implementation means having a function of displaying a question and processing an answer to this question, and communication control means for transmitting to the education system server the result of the processed answer to the question; and the education system server comprises test result storage means for storing by participant the processed result of the answer received, and test result editing means for appropriately editing and outputting the test result in accordance with the request from the terminal.

[2] The second aspect of the present invention is a network system according to claim 1, wherein the terminal further comprises education content storage means for storing an education content file which provides education information to the participant, and the education implementation means comprises a function of displaying to the participant the education content appropriately read out from the education content storage means.

The participant may thereby efficiently receive education without being troubled space-wise or time-wise.

[3] The third aspect of the present invention is a network system according to paragraph [1] or paragraph [2] above, wherein the terminal further comprises authentication means for identifying whether the participant is a legitimate participant and picture control means for picturizing image information; the picture control means picturizes the image of the participant at an appropriate timing while the education implementation means is implementing education; and the communication control means transmits the image to the education system server at an appropriate timing.

The educational achievement of each participant can thereby be accurately known.

(Seminar Style)

[5] The fifth aspect of the present invention is a network system in which a terminal comprising communication means and an education system server are connected communicably via a network, further comprising a display device for storing education contents and displaying said education content to the participant; the terminal comprises first education implementation means having a function for displaying a question, and communication control means for transmitting an answer to the question to the education system server; and the education server comprises question storage means for storing a question corresponding to the education content, question selection means for returning a question appropriately selected in accordance with the request from said terminal, second education implementation means for processing the answer received, test result storage means for storing by participant the processed result of the answer received, and test result editing means for appropriately editing and outputting the test results in accordance with the request from the terminal.

Education in a seminar style can thereby be conducted efficiently.

(PET Terminal)

[4] The fourth aspect of the present invention is a terminal connected communicably via a network, comprising: education content storage means for storing the education content file which provides education information; education implementation means having a function of displaying the education content appropriately read out from the education content storage means and a question corresponding to this education content, and processing an answer to this question; authentication means for identifying whether the participant is a legitimate participant; picture control means for picturizing the image of the participant at an appropriate timing while the education implementation means is implementing education; and communication control means for transmitting the result of the processed answer to the question to the education system server and transmitting the image to the education system server at an appropriate timing.

The participant may thereby efficiently receive education without being troubled space-wise or time-wise.

(Education System Server)

[6] The sixth aspect of the present invention is an education system server connected communicably via a network, comprising: question storage means for storing a question corresponding to the education content; question selection means for returning a question appropriately selected in accordance with the request from a plurality of terminals; education implementation means for processing an answer to the question received; test result storage means for storing by participant the result of the processed answer; and test result editing means for appropriately editing and outputting the test result in accordance with the request.

The educational achievement of each participant can thereby be accurately known in the seminar style education.

[7] The seventh aspect of the present invention is a network system according to any one of paragraphs [1] to [3] or paragraph [5] above, wherein the education system server is connected to a computer of an institution to which the participant belongs, and the test result editing means appropriately edits and outputs the test result in accordance with the request from the computer of the institution.

[8] The eighth aspect of the present invention is an education system server according to paragraph [6] above, wherein the education system server is connected to a computer of an institution to which the participant belongs, and the test result editing means appropriately edits and outputs the test result in accordance with the request from the computer of the institution.

The output data may thereby be utilized in future education.

[9] The ninth aspect of the present invention is a network system according to any one of paragraphs [1], [2] or [5] above, wherein said terminal is configured to be portable.

According to this aspect of the present invention, a participant who is committed locally is thereby able to efficiently receive education.

### BRIEF DESCRIPTION OF THE DRAWINGS

FIG. 1 is a system structural diagram for explaining an embodiment of the present invention in its entirety;

FIG. 2 is a diagram for explaining the overall system on the terminal side of the embodiment;

FIG. 3 is a diagram for explaining the individual personal information file retained on the terminal side of the embodiment;

FIG. 4 is a diagram for explaining the education content file retained on the terminal side of the embodiment;

FIG. 5 is a diagram for explaining the overall system on the education system server side of the embodiment;

FIG. 6 is a diagram for explaining the entire individual personal information file retained on the education system server side of the embodiment;

FIG. 7 is a diagram for explaining the individual medical institution information file retained on the education system server side of the embodiment;

FIG. 8 is a front view showing the terminal of the embodiment;

FIG. 9 is a flowchart for explaining the operation of the terminal when a person is receiving education;

FIG. 10 is a flowchart for explaining the operation of the terminal when a person is receiving education;

FIG. 11 is a diagram for explaining the terminal screen when a person is receiving education;

FIG. 12 is a diagram for explaining the terminal screen when a person is receiving education;

FIG. 13 is a diagram for explaining the terminal screen when a person is receiving education;

FIG. 14 is a diagram for explaining the terminal screen when a person is receiving education;

FIG. 15 is a diagram for explaining the terminal screen when a person is receiving education;

FIG. 16 is a flowchart for explaining the authentication operation of the education system server of the embodiment;

FIG. 17 is a flowchart for explaining the operation of the education system server accumulating the test results;

FIG. 18 is a flowchart for explaining the operation of the education system server transmitting the test result to the terminal;

FIG. 19 is a flowchart for explaining the operation of editing and processing the test result retained in the education system server;

FIG. 20 is a system structural diagram for explaining another embodiment (seminar style) of the present invention in its entirety;

FIG. 21 is a diagram for explaining the overall system on the education system server side for providing education in a seminar style;

FIG. 22 is a diagram for explaining a plurality of test patterns; and

FIG. 23 is a flowchart for explaining the operation implementing a test in a seminar style.

### DETAILED DESCRIPTION OF THE PREFERRED EMBODIMENT

1. Overall Structure

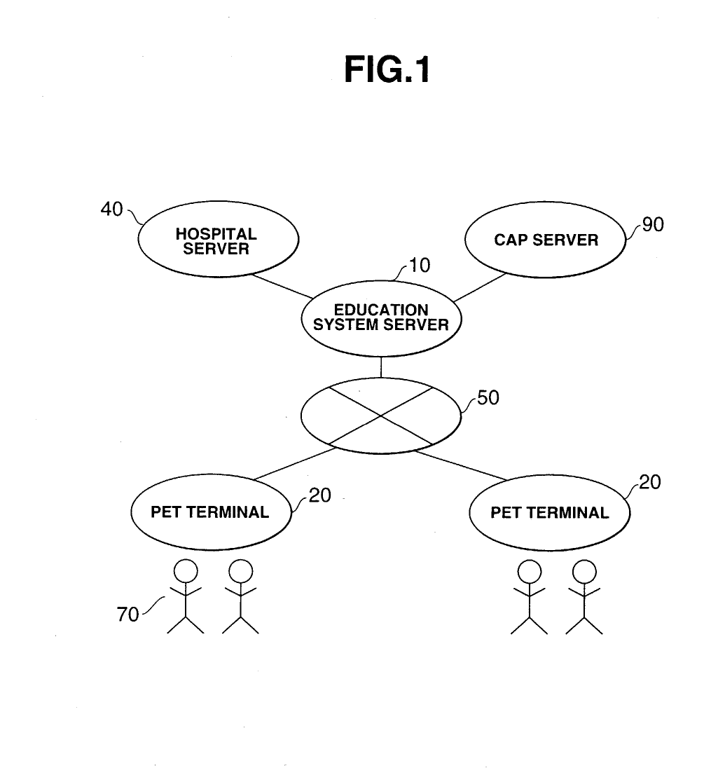

The overall structure of an embodiment of the present invention is now explained with reference to FIG. 1.

FIG. 1 is a system structural diagram showing the outline of the present system. A medical practitioner, a nurse 70 for example, receiving education with the present system will be educated in a conversational format with a portable PET terminal 20 having installed therein a program PET (Personal Educational Tool) described later in accordance with one's own job description and expertise. A test is conducted after the completion of each chapter (lesson) of this education program, and this test result is transmitted to the education system server 10 from the PET terminal 20 via a network 50. An education system server 10 accumulates the test result sent from the PET terminal 20 in its internal database.

The education system server 10 compiles the test results per participant based on the database, conveys such results to the PET terminal 20 or each individual 70 via the network 50, and further compiles the test results in a prescribed format per medical institution to which the participant belongs and conveys the results thereof to a hospital server 40 belonging to the respective medical institutions.

By connecting the education system server 20 with a server 90 of CAP, which is an accreditation organization, the test results of the present education program may be reflected on the authentication criterion or standard, utilized as materials for CAP actually auditing the medical institutions, or employed as materials for authentication or certification. Contrarily, the authentication or certification criterion of CAP may be reflected on the present education system, and the present education program may be renewed in accordance therewith.

2. Structure of PET Terminal

PET is structured from the respective programs indicated below.

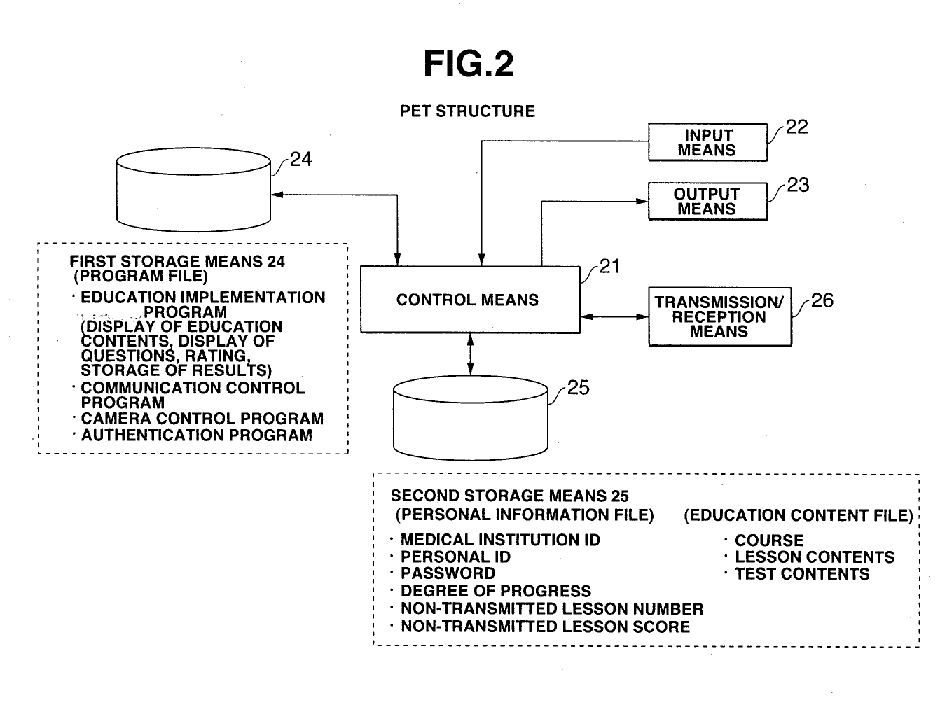

Next, the structure of the PET Terminal 20, which is used by each of the medical practitioners directly receive education, is explained with reference to FIGS. 2 to 4. As shown in FIG. 2, the PET terminal 20 comprises an input means 22 for receiving inputs from the participant, a first storage means 24 for storing a program to be executed on the terminal, a second storage means 25 for storing the respective data, a transmission/reception means 26 for conducting the transmission/reception of data with the education system server 10, and a control means 21 for controlling the overall PET terminal.

The program file accumulated in the first storage means 24 comprises an education implementation program (for displaying the education contents, displaying and rating the test results, and storing such test results) as the education implementation means, a communication control program as the communication means for controlling the transmission/reception means 26 for communicating with the education system server 10, an authentication program as the authentication means for authenticating whether the participant has been registered in the present system beforehand, and a camera control program as the picture control means provided to the PET terminal and for controlling the camera picture.

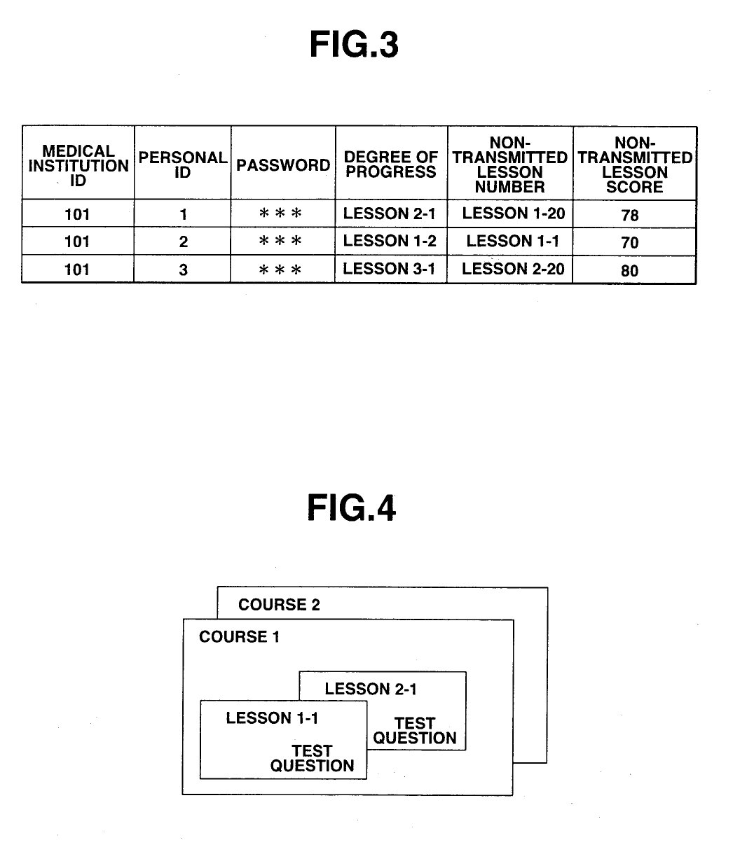

The second storage means 25 as the education content storage means comprises an individual personal information file and an education content file. As shown in FIG. 3, the individual personal information file has fields containing the participant's medical institution ID, his/her personal ID, password, progress of lesson, non-transmitted lesson number, and non-transmitted lesson score. Meanwhile, the education content file, as shown in FIG. 4, has the respective courses and a plurality of lesson contents contained in such courses as well as the test questions per such lesson.

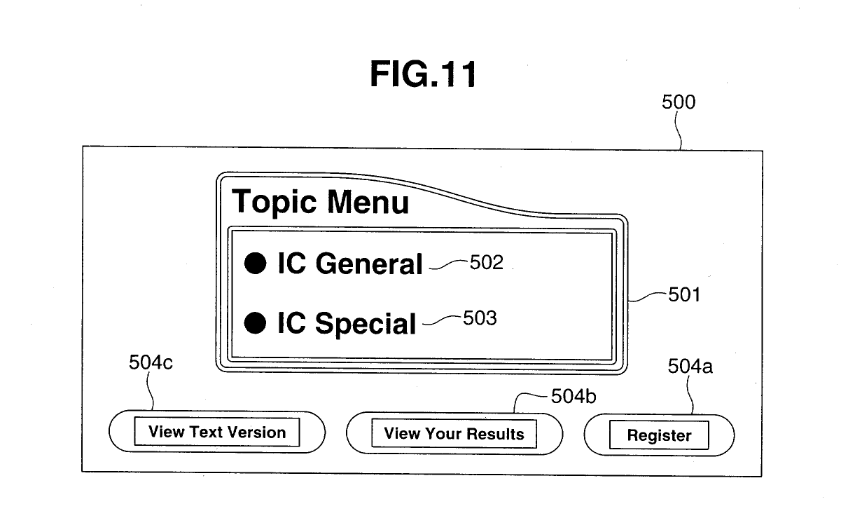

The education contents are provided with various pieces of educational information relating to medical care, sanitation, medicine, and so on, and, for instance, “IC General” is provided as the initial course, and “Standard Precautions and Personal Protective Equipment (PPE)” is provided as one of the lessons of such initial course (described later with reference to FIGS. 11 to 15). The respective lessons of the education content file, including the tests thereof, are conducted in a short time period, and, for example, are arranged for completion in 15 minutes. Thus, the participant may take lessons in a short time period.

3. Structure of Education System Server

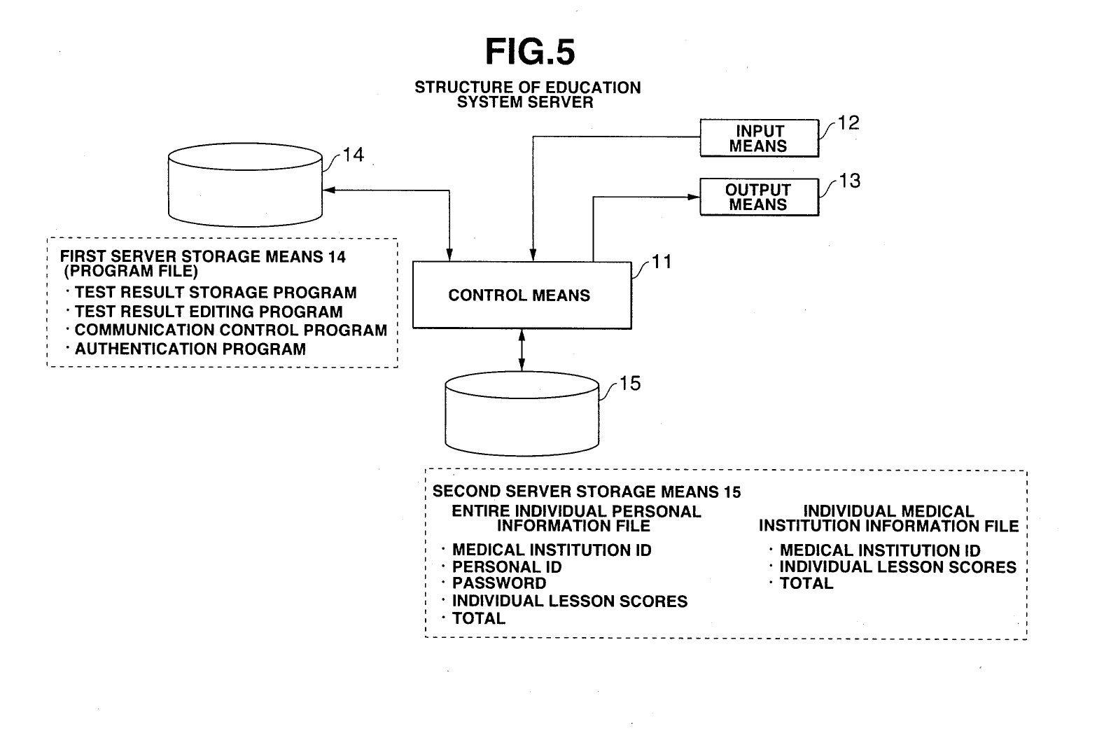

The structure of the education system server is now explained with reference to FIGS. 5 to 7.

As illustrated in the system structural diagram of FIG. 5, the education system server 10 comprises an input means 12 for inputting the request or test result from the PET terminal 20, an output means 13 for outputting data to the PET terminal 20, a first server storage means 14, a second server storage means 15, and a control means 11 for controlling the operation of the overall education system server.

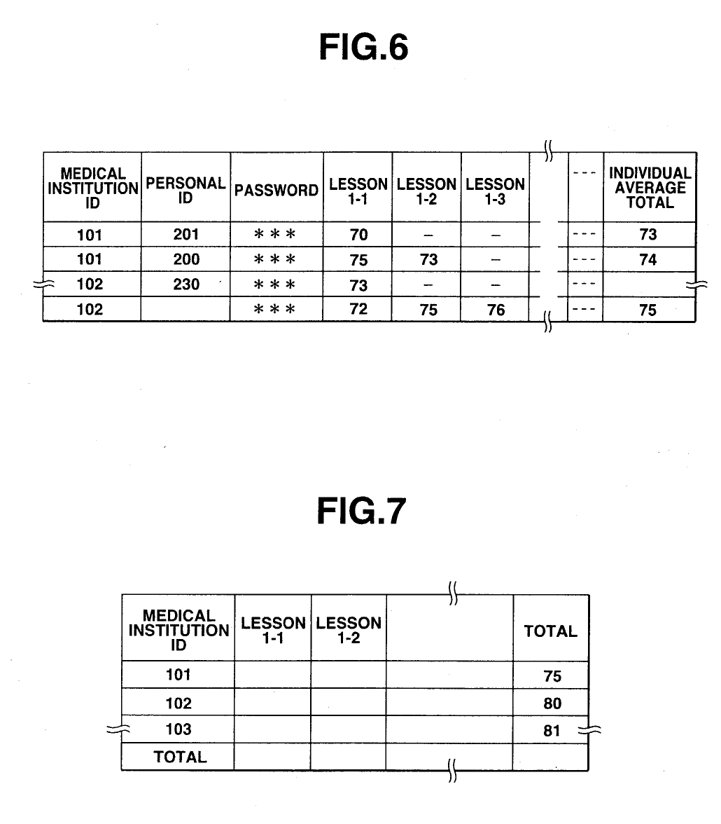

The second server storage means 15 stores two types of databases, one is the entire individual personal information file for retaining the entire information of persons participating in the present education system as shown in FIG. 6, and the other is an individual medical institution information file for retaining information edited for each medical institution as shown in FIG. 7.

The first server storage means 14 has various program files, including a test result storage program as the test result storage means, a test result editing program as the test result editing means, a communication control program as the communication control means, and an authentication program as the authentication means. The test result storage program stores the test results sent from the PET terminal 20 in every individual personal information file within the second server storage means 15. The test result editing program edits the results per medical institution from every individual personal information file, creates the foregoing individual medical institution information file, and edits and output this in a prescribed format. The communication control program controls the input means 12 and the output means 13. And an authentication program authenticates the data from the PET terminal 20.

4. Learning Mode on PET Terminal

An embodiment of learning on the PET terminal is explained with reference to FIG. 2 and FIGS. 8 to 15.

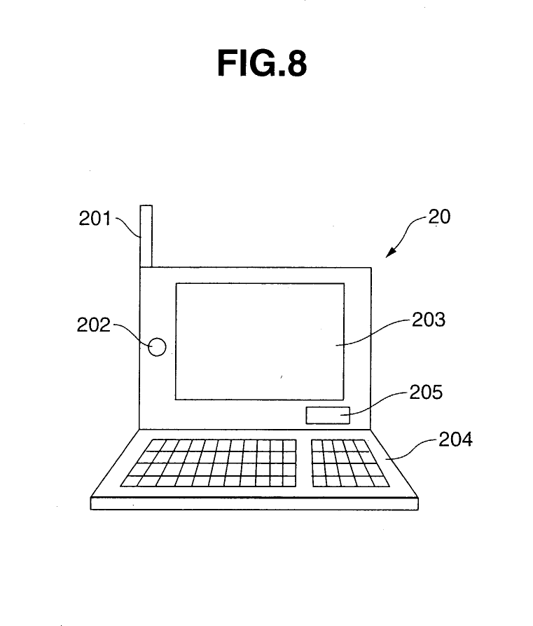

FIG. 8 is a front view of the PET terminal 20. As depicted in FIG. 8, the terminal 20 comprises a display 203, a keyboard 204, a communication device 201, a speaker 205 and a camera 202. With the terminal 20, various pieces of knowledge and information demanded in medical practitioners are displayed as an educational program on the display 203 in text and images, and further conveyed verbally from the speaker 205. Display of moving images is also possible on the display 203 in order to convey something that requires a series of movements within the program; for instance, the method of sterilization, in an easy-to-understand manner.

The camera 205 is used to authenticate the participant. In other words, it is used in the education system server 20 to determine whether the plurality of test results sent from the terminal 20 belong to the same individual. In consideration of the communication traffic, the image data picturized with the camera 202 is sent to the education system server 10 via the communication device 101 every definite period of time.

The state where a participant is actually receiving education is now explained.

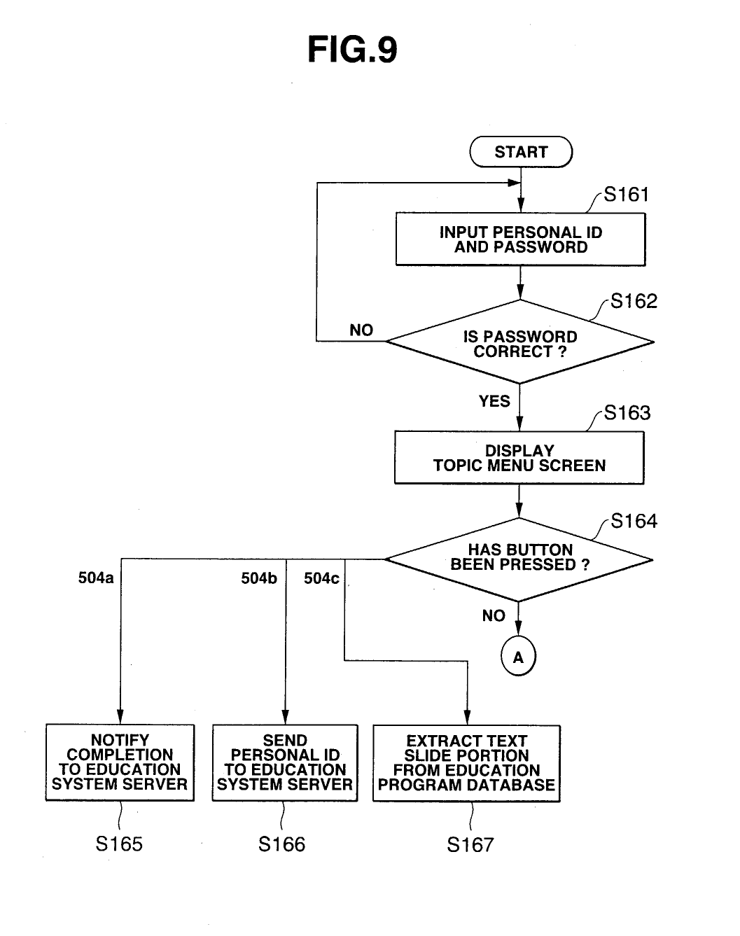

The control means 21 makes the participant input the login name and password via the input means 22 (S161 of FIG. 9). The authentication program 24 checks whether its contents have been pre-registered in the individual personal information file 25 (S162 of FIG. 9). If the login name and password are correct, the education implementation program 24 displays the relevant portion of the education content file 25 on the screen 500 as illustrated in FIG. 11 via the output means 23 (S163 of FIG. 9).

As depicted in FIG. 11, a topic menu screen 501 is displayed in the center of the screen 500. A version title 502 of “IC General” and a version title 503 of “IC Special”, which are educational courses, are displayed therein, and the participant selects a title in accordance with his/her learning progress.

Buttons 504a, 504b and 504c are displayed at the bottom of the screen 501. The button 504a is to be pressed when the participant completes the entire education program, and, when this button 504a is clicked, the control means 21 activates the communication control program 24 and transmits, via the transmission/reception means 26, such participant's personal ID to the education system server 10, and conveys that such participant finished participating in every education program (S165 of FIG. 9).

The button 504b is clicked when the participant wishes to display the previous test results. When the button 504b is pressed, the control means transmits, via the transmission/reception means 26, the relevant personal ID to the education system server 10, and downloads, via the transmission/reception means 26, the previous test results of such participant from every individual personal information file of the education server 10 to the PET terminal 20 and displays this on the output means 23 (S166 of FIG. 9).

The button 504c is used for displaying all education contents in a text slide format. The control means 21 searches the relevant data from the education content file 25 and displays the same (S167 of FIG. 9).

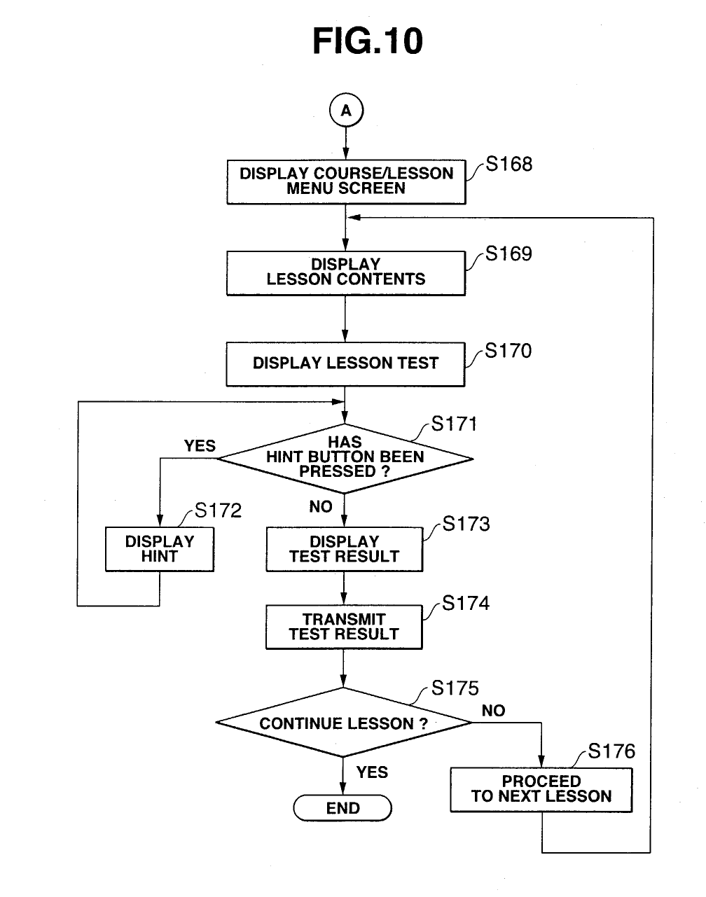

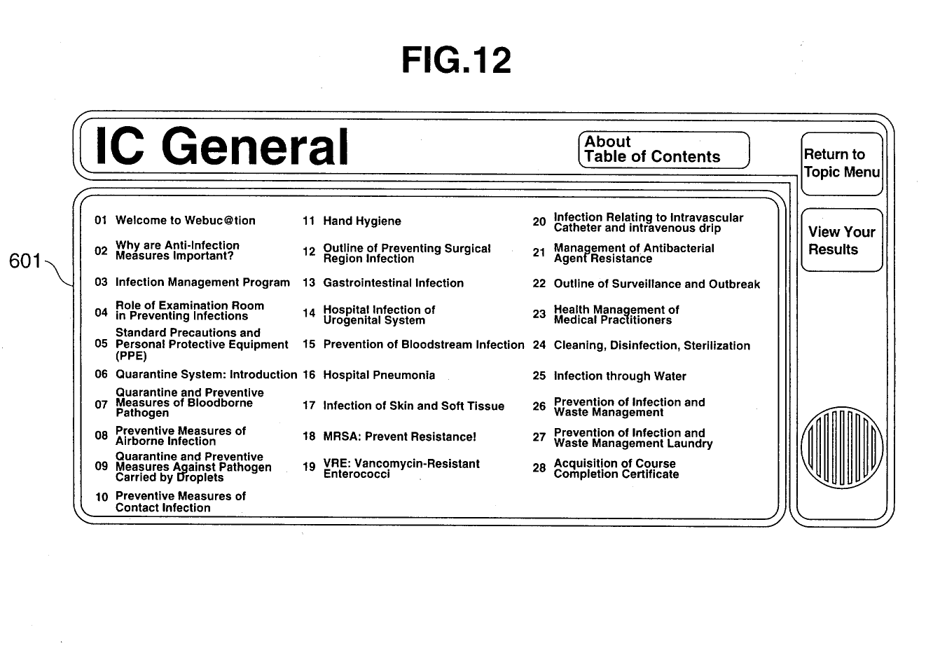

When a course is selected in the topic menu screen 501, the education implementation program searches the education content file stored in the second storage means 25, and, as shown in FIG. 12, displays a list of lessons (chapters) prepared within the course as a course/lesson menu screen 601 (S168 of FIG. 10). In consideration of medical practitioners who are often temporally committed, each lesson is set to a short time period including the test, set to approximately 15 minutes for instance.

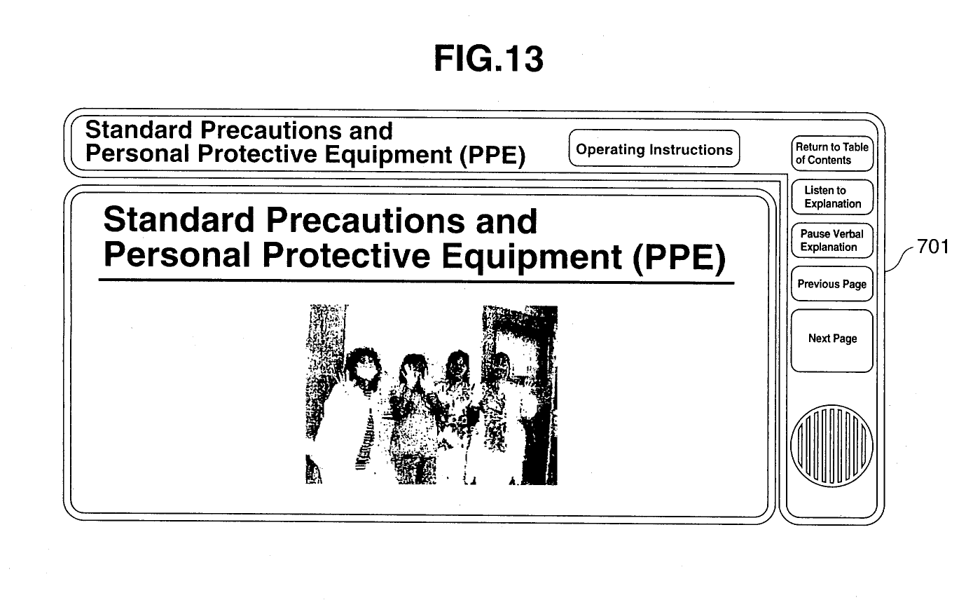

When the participant selects a certain lesson, such lesson begins. FIG. 13 represents an example of a lesson screen 701. As illustrated in FIG. 13, the education implementation program displays the lesson screen 701, and, for example, displays an animation for education accompanying movement, and further outputs verbal instructions (S169 of FIG. 10).

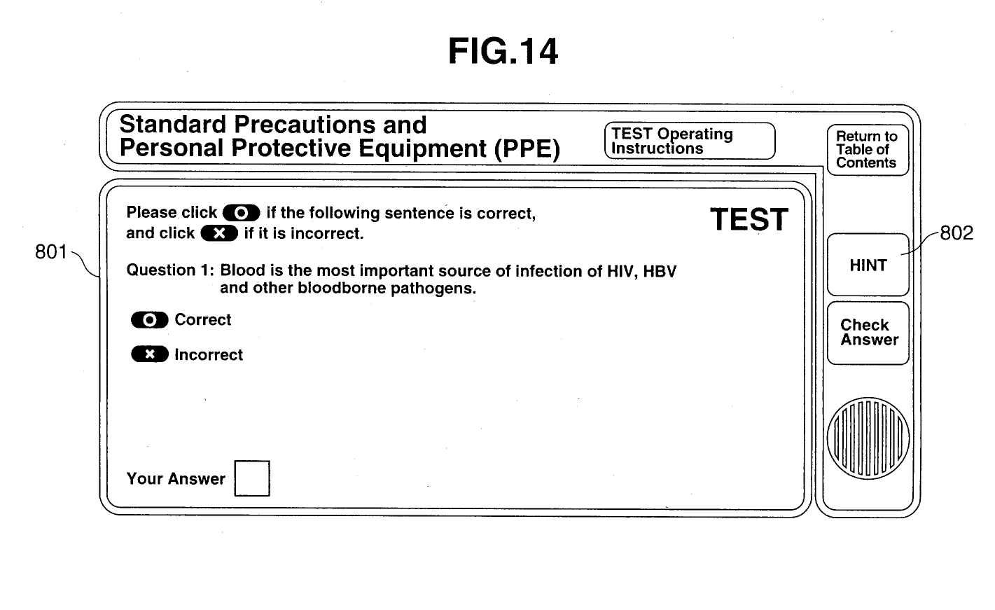

When one lesson is finished, the participant takes a test to confirm whether he/she understood the lesson contents. As shown in FIG. 14, the education implementation program displays the test contents on the test screen 801 (S170 of FIG. 10).

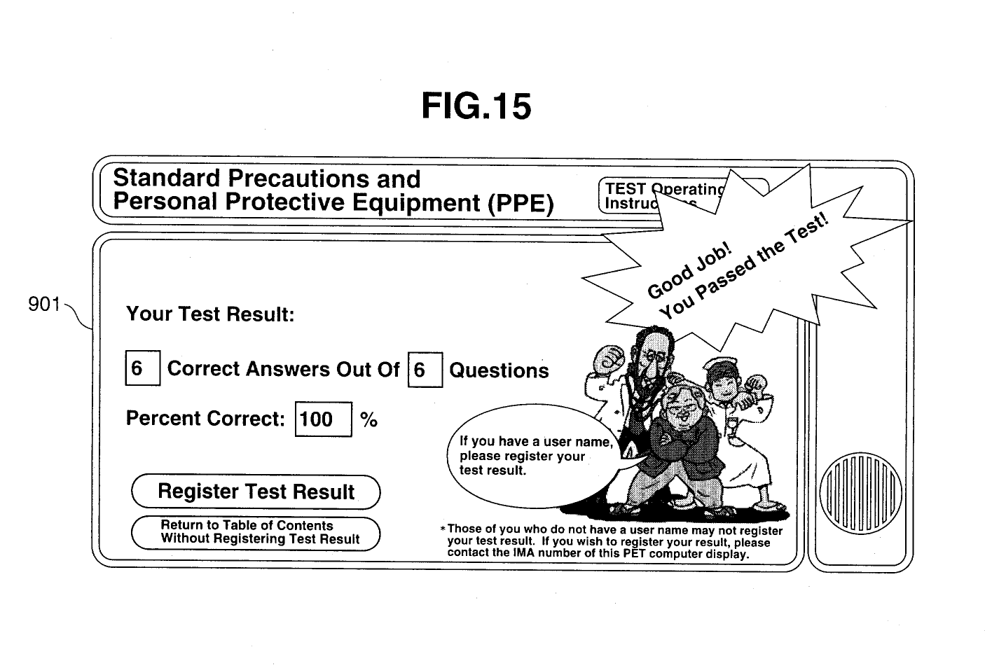

When the participant takes the test, as depicted in FIG. 15, the test result is displayed on the test result display screen 901 (S173 of FIG. 10). In order to facilitate the participant's test, a “hint” of the test is displayed or the narration thereof is output when the participant clicks the hint button 802 (S171, S172 of FIG. 10). If the percent correct exceeds a prescribed value, 70% for example, the participant may then send this result to the education system server 20 via the network (S174 of FIG. 10).

If the test result is not sent, the lesson number and score are accumulated in the individual personal information file in the second storage means 25 by the education implementation program, and sent to the education system server 10 together with the test result obtained at the end of tests conducted for any subsequent lessons.

Thereafter, it is judged whether the participant will continue to take the subsequent lesson (S175 of FIG. 10), and, if the participant is to continue, the routine proceeds to the next lesson (S176 of FIG. 10), and the lesson contents are displayed (S169 of FIG. 10). This procedure is repeated thereafter.

While the participant is taking a series of lessons, the camera control program appropriately picturizes the face of the participant from the camera 202 provided to the PET terminal 20 and sends the image data thereof to the education system server 10 via the transmission/reception means 26. This image data is sent once every prescribed time in consideration of the communication traffic and the like. This data is used for authenticating the participant with the education system server 10. The participant may also be requested to answer a questionnaire regarding the present education program.

5. Storage Mode of Test Results by Server

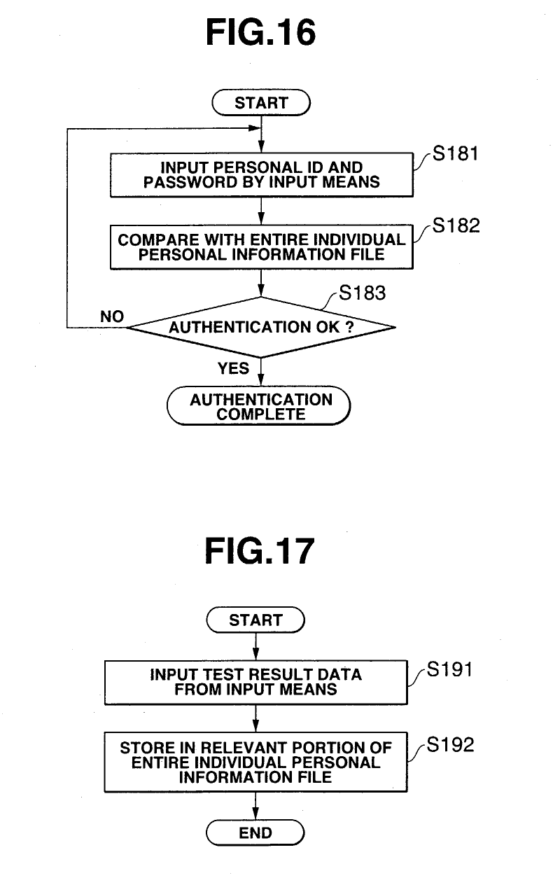

The server's storage mode of the test results sent from the PET terminal 20 is described with reference to FIG. 5, FIG. 16 and FIG. 17.

Foremost, details of the second server storage means 15 are described with reference to FIGS. 5 to 7. As described above, the second server storage means 15 is structured from an entire individual personal information file and an individual medical institution information file.

As shown in FIG. 6, the entire individual personal information file contains all necessary data of every participant including classification by medical institutions. In other words, it contains the fields of medical institution ID, ID of each participant, password of each participant, score per lesson of each participant, total score of each participant, and personal total score per lesson.

As shown in FIG. 7, the individual medical institution information file has the compiled data of the entire individual personal information file described above. That is, this is a compilation of the total score of each participant and the personal total score per lesson for each medical institution.

The authentication operation is foremost explained with reference to FIG. 5 and FIG. 16.

The participant ID, password or the participant's image data is sent from the PET terminal 20 via the input means 12 (S181). The authentication program compares the input data and the personal ID and password of the entire individual personal information file (S182, S183). If authentication is confirmed, the authentication procedure is finished. If the received data is an image, such image is authenticated by being compared with the initially sent image data.

The control means 11 inputs the test results from the input means 12 (S191 of FIG. 17). The test result storage program as the test result storage means accumulates the input test results in the relevant field of the entire individual personal information file in the second server storage means 15 (S192 of FIG. 17).

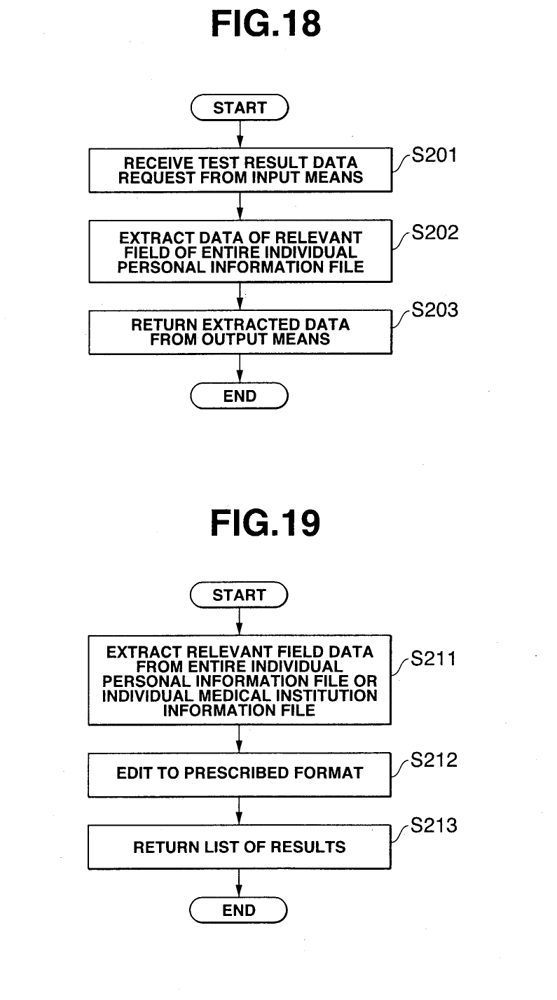

Moreover, when the previous test result data up to the previous lesson is requested from the PET terminal 20 (S201 of FIG. 18), as described above, the foregoing authentication procedure is conducted with the authentication program (c.f. FIG. 16). Thereafter, the test result editing program as the test result editing means searches the entire individual personal information file stored in the second server storage means 15 and removes the requested data from the relevant field (S202 of FIG. 18), and returns the removed data to the PET terminal 20 via the output means 13 (S203 of FIG. 18).

6. Formation/Editing Procedure of Education System Server

The operation of the education system server upon receiving a display request of the compiled test results from the medical practitioner who received the education of the present system or from the medical institution is now explained.

Foremost, when a request is received from the participant, the test result editing program as the test result editing means searches the entire individual personal information file using the relevant personal ID as the key (S211 of FIG. 19), edits the list of results per lesson in a prescribed format (S212 of FIG. 19) and then transmits this to the individual (S213 of FIG. 19).

When the request is received from the medical institution, the test result editing program extracts all personal test results belonging to such medical institution from the entire individual personal information file stored in the second server storage means 15 (S211 of FIG. 19), creates a list of results, edits the average score or average total score per lesson of such medical institution from the individual medical institution information file (S212 of FIG. 19), reflects this to the list of results, and thereafter returns the same (S213 of FIG. 19). The format of this list of results is arbitrary, and, for instance, a list of results of all practitioners or the medical institution may be created, a list of results for each internal division of such medical institution may be created, or a list of results for only the top-ranking participants or only the bottom-ranking participants may be created.

Further, the format of transmission to individuals or medical institutions may be via email or mail.

7. Embodiment of an Education System in Seminar Style

In the event that the foregoing personal education with the PET terminal is not possible due to the work shift of the medical institutions or medical practitioners, the present medical education may be conducted in a seminar style; that is, medical practitioners may receive the medical education at a predetermined time and place by employing a projector or the like.

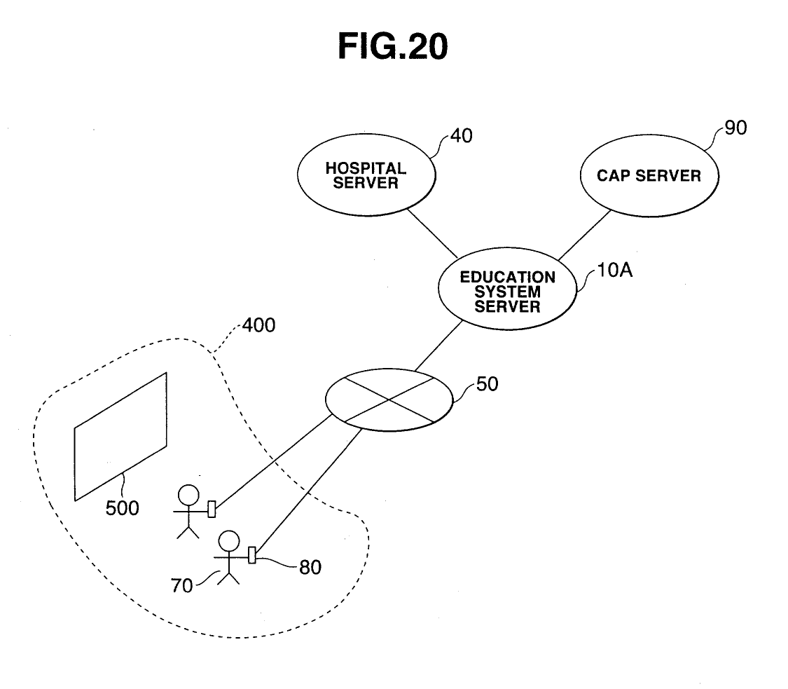

FIG. 20 shows the system structural diagram thereof. A certain number of medical practitioners 70 participate in the medical program of the present system at a seminar site 400. The participants participate in the present medical education program by viewing, for example, a projector 500 as the display device. The picture projected on this projector 500 or the verbal explanations thereof are approximately the same as those of the PET terminal 20 described above.

The test to be conducted after the completion of each lesson is conducted via a communication terminal, for example, a cellular phone 80 provided to the respective participants in advance. The operation of this test is explained below.

Each participant presses the button showing the completed lesson number and connects to the education system server via the network 50. The education system server 10A selects one test question among the plurality of test patterns prepared in advance, returns this to the cellular phone 80 via the network 50, and displays this on the display screen of the cellular phone. A different test is enabled for each participant of the same lesson by this function. Thus, the possibility of cheating will decrease and an appropriate test may thereby be conducted.

Next, when the participant 70 presses a button corresponding to the answer to the test displayed by the first education implementation means (not shown) on the cellular phone 80 in his/her hand, the data thereof is returned to the education system server 10A via the network 50. The education system server rates this data, and stores the result. It further conveys this result to the cellular phone 80.

The first education implementation means and communication control means contained in the cellular phone 80 is of a standard type of usage in cellular phones having internet browser function, as in an I-mode (trade mark) cellular phone in Japan for example, and the explanation thereof is omitted since they merely provide the respective functions of personal ID and lesson number notification, test content display, answer number notification, and result display during the seminar style lesson.

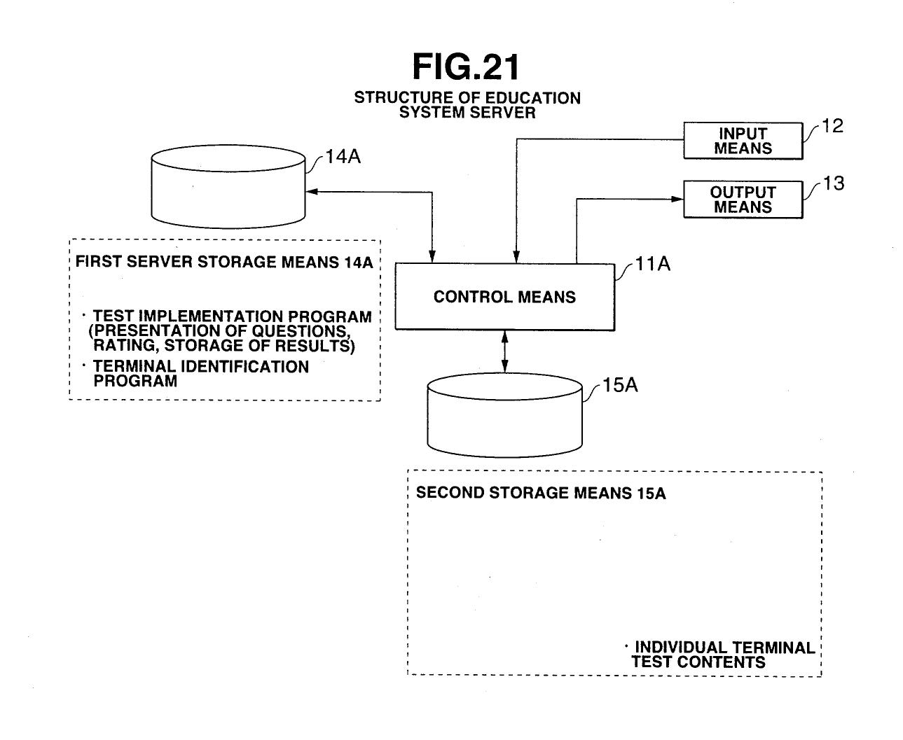

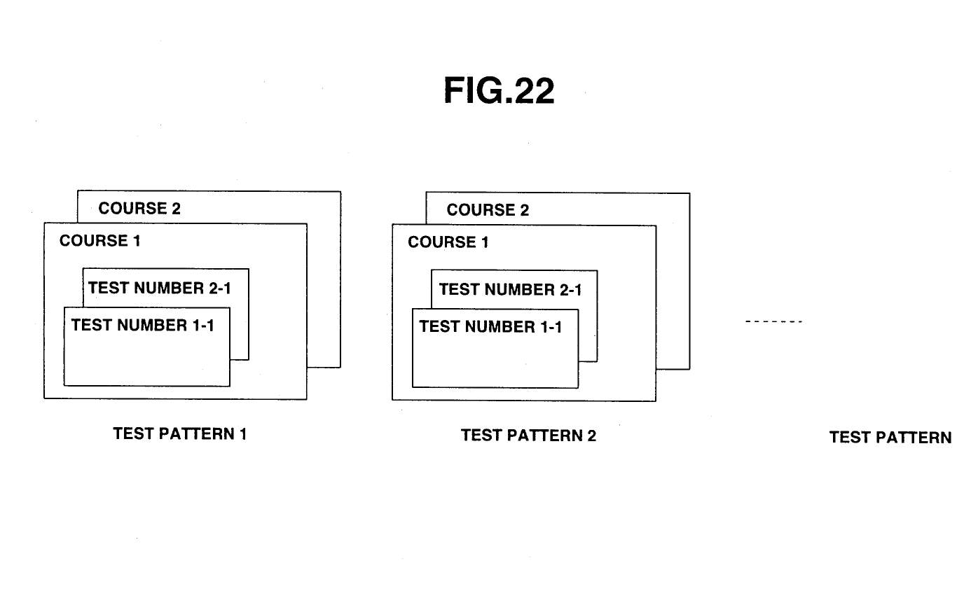

The education system server 10A comprises the first server storage means 14A and the second storage means 15A. The first server storage means 14A is structured by adding, to the respective programs of the first server storage means 14 of the education system server 10 explained with FIG. 5, a terminal identification program as the question selection means and test implementation program (presentation of questions, rating, storage of results) as the second education implementation means as shown in FIG. 21. The second storage means 15A is structured by adding the individual terminal test contents (c.f. FIG. 22) storage means as question storage means to the second server storage means 15 of the education system server 10.

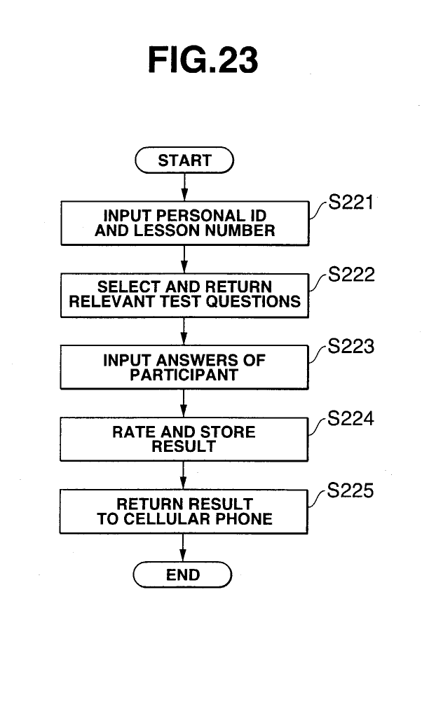

The control means 11A inputs the personal ID and lesson number from the cellular phone 80 via the input means 12 (S221 of FIG. 23). The terminal identification program selects a test question corresponding to the received terminal ID among the individual terminal test contents shown in FIG. 22. For example, the individual terminal test contents illustrated in FIG. 22 starts from test pattern 1, and contain a plurality thereof. Thus, the number of different types of tests that may be implemented is the same as the number of existing test patterns for the same lesson. The individual terminal identification program selects this test pattern per type of individual ID; that is, per type of cellular phone. This selection is made so that a test pattern displayed in a cellular phone will not be the same as a test pattern displayed in another cellular phone as much as possible.

The test implementation program sends this selected test question to the cellular phone 80 via the output means 13 (S222 of FIG. 23). Accordingly, a different test question can be distributed for each participant. Moreover, the same test question may be given for the same lesson to conduct a test where the multiple choice answers are counterchanged.

Next, the control means 11A inputs the answer data from the participant (S223 of FIG. 23). The test implementation program rates this answer, and stores the result in the entire individual personal information file within the second storage means 15A (S224 of FIG. 23). This test result is returned to the cellular phone 80 via the output means 13 (S225 of FIG. 23). The participant's learning progress may thereby be sought with accuracy.

Accordingly, an education program structured for a relatively short period of time on a terminal including portable one is able to alleviate the burden on medical practitioners who are often committed temporally and locally.

Further, by connecting the server of the insurance company to which the respective medical institutions are affiliated with the server of the present system, the ratio of medical practitioners achieving a prescribed result or higher may be utilized in calculating the insurance premium between the medical institution and insurance company, or discounts on the insurance premium may be given to medical practitioners who have achieved favorable results.

Although medical education was exemplified in the embodiments, the target education field of the present system is not limited thereto, and may be employed in educations of other fields by changing the contents of the education program.

According to the present invention, the participant may receive education on a terminal including portable terminal capable of carrying an education program. Thus, a participant who is often committed temporally and locally is thereby able to efficiently receive education.

Moreover, according to the present invention, since the test results of all participants of the present education system are retained on the education system server, the data thereof may be edited and processed in a prescribed format. Thus, the participant, the institution to which such participant belongs, and the accrediting institution can respectively utilize this edited and processed data.

What is claimed is:

1. A network system in which a terminal comprising communication means and an education system server are connected communicably via a network,
wherein said terminal comprises education implementation means having a function of displaying a question and processing an answer to this question, and communication control means for transmitting to said education system server the result of the processed answer to said question; and
said education system server comprises test result storage means for storing by participant the processed result of said answer received, and test result editing means for appropriately editing and outputting said test result in accordance with the request from said terminal.

2. A network system according to claim 1,
wherein said terminal further comprises education content storage means for storing an education content file which provides education information to the participant, and said education implementation means comprises a function of displaying to the participant the education content appropriately read out from said education content storage means.

3. A network system according to claim 1 or claim 2,
wherein said terminal further comprises authentication means for identifying whether the participant is a legitimate participant and picture control means for picturizing image information;
said picture control means picturizes the image of the participant at an appropriate timing while said education implementation means is implementing education; and
said communication control means transmits said image to said education system server at an appropriate timing.

4. A terminal connected communicably via a network, comprising:
education content storage means for storing the education content file which provides education information;
education implementation means having a function of displaying the education content appropriately read out from said education content storage means and a question corresponding to this education content, and processing an answer to this question;
authentication means for identifying whether the participant is a legitimate participant;
picture control means for picturizing the image of the participant at an appropriate timing while said education implementation means is implementing education; and
communication control means for transmitting the result of the processed answer to said question to the education system server and transmitting said image to the education system server at an appropriate timing.

5. A network system in which a terminal comprising communication means and an education system server are connected communicably via a network,
further comprising a display device for storing education contents and displaying said education content to the participant;
said terminal comprises first education implementation means having a function for displaying a question, and communication control means for transmitting an answer to said question to said education system server; and
said education server comprises question storage means for storing a question corresponding to said education content, question selection means for returning a question appropriately selected in accordance with the request from said terminal, second education implementation means for processing said answer received, test result storage means for storing by participant the processed result of said answer received, and test result editing means for appropriately editing and outputting said test results in accordance with the request from said terminal.

6. An education system server connected communicably via a network, comprising:
question storage means for storing a question corresponding to the education content;
question selection means for returning a question appropriately selected in accordance with the request from a plurality of terminals;
education implementation means for processing an answer to said question received;
test result storage means for storing by participant the result of the processed answer; and
test result editing means for appropriately editing and outputting said test result in accordance with the request.

7. A network system according to any one of claims 1 to 3 or claim 5, wherein said education system server is connected to a computer of an institution to which said participant belongs, and said test result editing means appropriately edits and outputs said test result in accordance with the request from the computer of said institution.

8. An education system server according to claim 6, wherein said education system server is connected to a computer of an institution to which said participant belongs, and said test result editing means appropriately edits and outputs said test result in accordance with the request from the computer of said institution.

9. A network system according to any one of claims 1, 2 or 5, wherein said terminal is configured to be portable.
